(19) United States
(12) Patent Application Publication
(10) Pub. No.: US 2004/0245482 A1
(43) Pub. Date: Dec. 9, 2004

(54) High heat radiating structure of gas sensor

(76) Inventor: Yasuyuki Sato, Kasugai-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/861,850

(22) Filed: Jun. 7, 2004

(30) Foreign Application Priority Data
Jun. 6, 2003 (JP) 2003-162512
Apr. 6, 2004 (JP) 2004-112418

(51) Int. Cl. G01N 27/26; G21G 4/00

(52) U.S. Cl. 250/493.1

(57) ABSTRACT

A high heat-radiating structure of a gas sensor is provided. The gas sensor includes a sensing element which is to be exposed to a measurement gas and a body in which the sensing element is installed. The body has an outer wall which includes a gas-exposed surface and an air-exposed surface. The gas-exposed surface is to be exposed to the measurement gas. The air-exposed surface is to be exposed to an atmospheric air. At least a portion of at least one of the air-exposed surface and the gas-exposed surface has an emissivity of 0.7 or more, thereby enhancing the heat radiation from inside to outside the body of the gas sensor to protect less heat resistant parts from thermal damage.

### BACKGROUND OF THE INVENTION

1. Technical Field of the Invention

The present invention relates generally to an improved structure of a gas sensor for use in determining the concentration of a specified component of gas, and more particularly to such a gas sensor constructed to achieve high heat radiation to minimize thermal damage thereto.

2. Background Art

The control of combustion in automotive engines using the concentration of oxygen in exhaust emissions is in general effective in the fuel economy and emission control.

Typical gas sensors designed to measure the concentration of oxygen in automotive exhaust gas have a sensing element installed therein. The sensing element includes an electrochemical cell made up of a solid electrolyte body and a pair of electrodes affixed to the solid electrolyte body. The electrochemical cell uses the atmospheric air as a reference gas to produce an electromotive force or a limiting current between the electrodes as a function of the concentration of oxygen in the exhaust gas. The gas sensors are, thus, constructed to be exposed both to the air and exhaust gas. Specifically, the gas sensors have an outer wall having two surfaces: one is exposed to the air, and the other is exposed to the exhaust gas. The air-exposed surface of the outer wall has formed therein air inlets through which the air is admitted into an air chamber in the gas sensor. The exhaust gas-exposed surface has formed therein gas inlets through which the exhaust gas is admitted into a measurement gas chamber in the gas sensor and is placed.

The gas sensors have a cylindrical housing which is partly fitted within a mount hole formed in the exhaust pipe of the engine for attachment of the gas sensors to the exhaust pipe. The air-exposed surface of the outer wall extends outside the exhaust pipe from the housing, while the exhaust gas-exposed surface extends inside the exhaust pipe from the housing.

The above type of gas sensors are usually equipped with parts less resistant to the heat. For instance, a water-repellent filter installed outside the air-exposed surface of the outer wall to block the intrusion of water into the gas sensor and an insulator fitted within an open end of the body of the gas sensor remote from the exhaust gas to retain electric lead wires or cables extending from inside to outside the body of the gas sensor are sensitive to the heat. The water-repellent filter is usually made of porous resin such as tetrafluoroethylene and lower in thermal resistance than metal or ceramic. The insulator is usually made of resin or rubber and lower in thermal resistance than metal or ceramic.

In recent years, the regulations for exhaust emissions of automotive engines have become sever. This has resulted in an increased temperature of the exhaust gas of the engines for emission control, thereby causing the gas sensors to be elevated in temperature undesirably. In some cases, the temperature of the gas sensors would exceed the limit of thermal resistance of the water-repellent filter or the insulator, as described above. In order to avoid this problem, the length of the gas sensors may be increased to reduce the quantity of heat transmitted to the water-repellent filter or the insulator or alternatively protrusions may be formed on the surface of the gas sensor to enhance the heat radiation from the body of the gas sensor. These approaches, however, are undesirable in terms of size or production costs of the gas sensors.

For instance, Japanese Patent First Publication No. 10-206373 teaches one of the above approaches to the lengthening of the gas sensors. U.S. Pat. No. 6,477,887 B1 discloses a typical structure of a gas sensor of the type as described above.

### SUMMARY OF THE INVENTION

It is therefore a principal object of the invention to avoid the disadvantages of the prior art.

It is another object of the invention to provide an improved structure of a gas sensor designed to enhance heat radiation from inside to outside the gas sensor to minimize a rise in temperature within a body of the gas sensor.

According to one aspect of the invention, there is provided a high heat radiating gas sensor which may be employed in automotive air-fuel ratio control or emission control. The gas sensor comprises: (a) a sensing element which is to be exposed to a measurement gas and works to produce a signal as a function of concentration of a specified component of the measurement gas; and (b) a body in which the sensing element is installed. The body has an outer wall which includes a gas-exposed surface and an air-exposed surface. The gas-exposed surface is to be exposed to the measurement gas. The air-exposed surface is to be exposed to an atmospheric air. At least a portion of the air-exposed surface has an emissivity of 0.7 or more, thereby enhancing heat radiation from inside to outside the air-exposed surface to protect a less heat-resistant part of the gas sensor from thermal damage.

In the preferred mode of the invention, the emissivity of the at least the portion of the air-exposed surface is preferably 0.85 or more.

The emissiviy is a ratio of radiation of an electromagnetic wave whose wavelength is 3 to 25 μm emitted from the at least the portion of the air-exposed surface to radiation of that emitted from a perfect blackbody radiator at the same temperature.

The body has a length with a base end and a top end opposed to the base end. The top end is to be exposed to the measurement gas. The at least the portion of the air-exposed surface having an emissivity of 0.7 or more occupies an area of the outer wall ranging over 0.5H from the base end in a lengthwise direction of the body where H is the length of the body.

The least the portion of the air-exposed surface is covered with an oxidized film.

The at least the portion of the air-exposed surface may alternatively be covered with a preselected coating.

The body also has an inner wall which includes an inner surface opposed to the air-exposed surface. At least a portion of the inner surface has an emissivity of 0.7 or more.

The at least the portion of the inner surface having an emissivity of 0.7 or more occupies an area of the inner wall ranging over 0.5H from the base end in a lengthwise direction of the body where His the length of the body.

According to the second aspect of the invention, there is provided a gas sensor which comprises: (a) a sensing element which is to be exposed to a measurement gas and works to produce a signal as a function of concentration of a specified component of the measurement gas; and (b) a body in which the sensing element is installed. The body has an outer wall which includes a gas-exposed surface and an air-exposed surface. The gas-exposed surface is to be exposed to the measurement gas. The air-exposed surface is to be exposed to an atmospheric air. The body also has an inner wall which includes an inner surface opposed to the air-exposed surface. At least a portion of the inner surface has an emissivity of 0.7 or more, thereby enhancing heat radiation from inside to outside the inner surface to protect a less heat-resistant part of the gas sensor from thermal damage.

In the preferred mode of the invention, the emissivity of the at least the portion of the inner surface is preferably 0.85 or more.

The emissiviy is a ratio of radiation of an electromagnetic wave whose wavelength is 3 to 25 μm emitted from the at least the portion of the inner wall to radiation of that emitted from a perfect blackbody radiator at the same temperature.

The body has a length with a base end and a top end opposed to the base end. The top end is to be exposed to the measurement gas. The at least the portion of the inner surface having an emissivity of 0.7 or more occupies an area of the inner wall ranging over 0.5H from the base end in a lengthwise direction of the body where H is the length of the body.

The at least the portion of the inner surface is covered with an oxidized film.

The at least the portion of the inner surface may alternatively be covered with a preselected coating.

In each of the first and second aspects of the invention, the sensing element includes a top end portion and a base end portion opposed to the top end portion. The top end portion is to be exposed to a measurement gas and works to produce the signal as a function of the concentration of the specified component of the measurement gas. The gas sensor further comprises: (a) a hollow cylindrical housing having a top end close to the top end portion of the sensing element and a base end close to the base end portion of the sensing element; (b) a first cylindrical insulator through which the sensing element passes, the first cylindrical insulator being disposed in the housing, having a top end close to the top end of the sensing element and a base end close to the base end of the sensing element; (c) a second cylindrical insulator having a base end close to the base end portion of the sensing element and a top end close to the top end portion of the sensing element, the second cylindrical insulator disposed at the top end thereof on the base end of the first cylindrical insulator to cover the base end portion of the sensing element; (d) a measurement gas cover installed on the top end of the housing to cover the top end portion of the sensing element; and (e) an air cover installed on the base end of the housing to cover the base end portion of the sensing element. The air cover is to be exposed to an atmospheric air and has a top end close to the top end of the sensing element and a base end close to the base end of the sensing element. The air cover includes a base portion, a top portion, a middle portion between the base portion and the top portion, and a shoulder between the base portion and the middle portion. The shoulder is in abutment with the base end of the second cylindrical insulator through an annular disc spring to establish a joint of the first and second cylindrical insulators. The base portion has a diameter D1, the middle portion has a diameter D2, the top portion has a diameter D3. The diameters D1, D2, and D3 meet conditions of D3<D2<D1 and (D1+D3)/2≦D2≦0.9D1, thereby ensuring the assembling of the air cover, the upper and lower insulators, and the housing.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor according to the first embodiment of the invention;

FIG. 2 is a side view which shows the gas sensor of FIG. 1 when installed in an exhaust pipe of an automotive engine;

FIG. 3 is a longitudinal sectional view which shows a modification of the gas sensor of FIG. 1;

FIG. 4 is a view which shows installation of each test sample on an emissivity measurement device;

FIG. 5 is a view which shows a table listing specifications of test samples of a gas sensor and test results;

FIG. 6 is a longitudinal sectional view which shows the structure of an air cover of a gas sensor according to the second embodiment of the invention;

FIG. 7 is a partially longitudinal sectional view which shows installation of the air cover of FIG. 6; and

FIG. 8 is a graph which shows a relation between heat radiation from an air cover of test samples and the diameter of the air cover.

### DESCRIPTION OF THE PREFERRED EMBODIMENTS

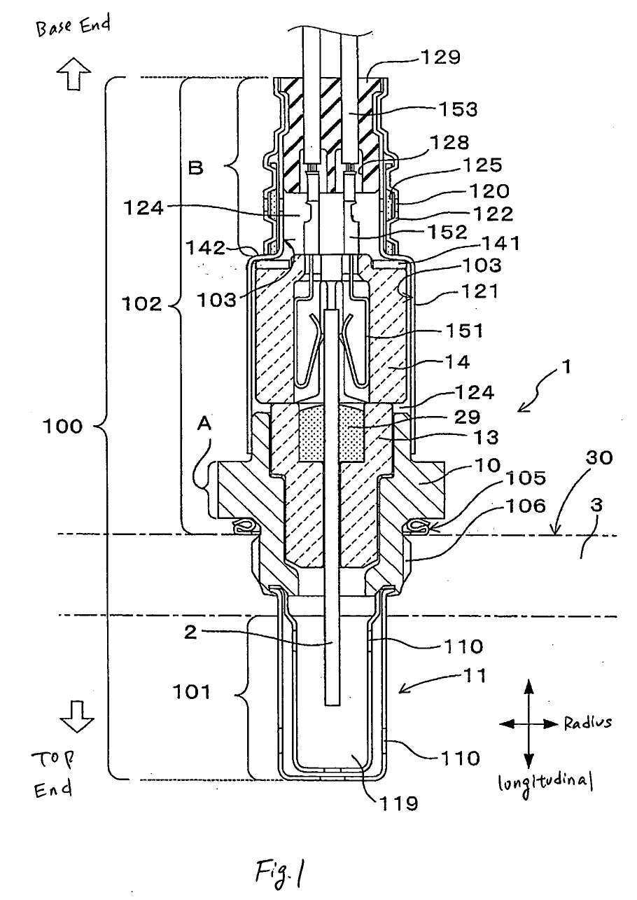

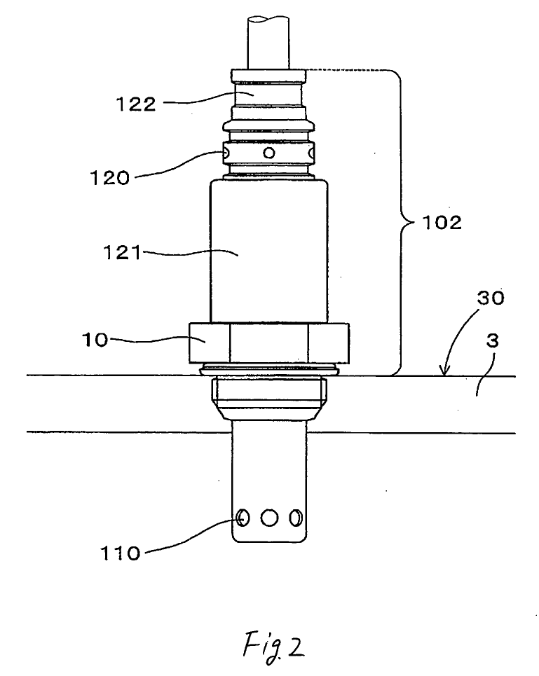

Referring to the drawings, wherein like reference numbers refer to like parts in several views, particularly to FIGS. 1 and 2, there is shown a gas sensor 1 according to the first embodiment of the invention. The gas sensor 1 internally includes a sensing element 2 working to measure the concentration of a specified gas component contained in a gas to be measured (will also be referred to as a measurement gas below). The sensing element 2 may be implemented by either of a laminate type and a cup-shaped type, as are well known in the art. The gas sensor 1 may be designed to measure the concentration of NOx, CO, HC, or/or 02 contained in exhaust emissions of automotive engines for use in air-fuel ratio control or emission control of the engine. The following discussion will refer, as an example, to an O₂ sensor (also called an air-fuel ratio sensor) for measuring the concentration of O₂ in exhaust gas of the engine.

The gas sensor 1 has a body of a preselected length which has an outer wall 100. The outer wall 100 has a gas-exposed surface 101 exposed to the measurement gas and an air-exposed surface 102 exposed to the atmospheric air. The emissivity of at least a portion of each of the air-exposed surface 102 and an inner air-exposed surface 103 opposed to the air-exposed surface 102 is higher than or equal to 0.7, preferably higher than 0.85 or more, and more preferably equal to 1.0 in order to enhance the heat radiation from inside the outer wall 100 of the gas sensor 1 to minimize thermal damage to less heat-resistant parts of the gas sensor 1. It is advisable that at least one of the air-exposed surface 102 and the gas-exposed surface 103 have an emissivity within one of those ranges.

In use, the gas sensor 1 is, as clearly illustrated in FIGS. 1 and 2, installed in an exhaust pipe 3 of an automotive internal combustion engine (not shown). The installation is achieved by fastening a housing 10 into a threaded sensor mount hole (not shown) formed in the exhaust pipe 3. The top portion (i.e., a lower portion, as viewed in the drawings) of the gas sensor 1 is exposed to the exhaust gas (i.e., the measurement gas) of the engine to measure the concentration of oxygen (O₂) contained in the exhaust gas which is used in determining an air-fuel ratio of a mixture in a combustion chamber (not shown) of the engine as a function of the concentration of oxygen.

The sensing element 2 consists essentially of a solid electrolyte plate and two electrodes (not shown) affixed to the solid electrolyte plate. One of the electrodes is exposed to a measurement gas atmosphere 119 (i.e., the exhaust gas), while the other electrode is exposed to the air atmosphere 124. The air atmosphere 124 is created within the gas sensor 1 by the ambient air used as a reference gas in determining the concentration of oxygen within the measurement gas atmosphere 119. The structure and operation of this type of sensing element is well known in the art, and explanation thereof in detail will be omitted here.

The gas sensor 1 includes the housing 10 and the sensing element 2. The housing 10 is made of a hollow cylinder. The sensing element 2 is partly fitted within a lower insulation porcelain 13 installed in the housing 10 which is made of a hollow cylinder.

A hermetic sealing material 29 is placed between the sensing element 2 and the lower insulator 13 to inhibit the flow of a gas. The sealing material 29 forms an interface between the air atmosphere 124 and the measurement gas atmosphere 119.

The housing 10 has installed in a top end thereof a protective cover assembly 11 which has a double-walled structure. The protective cover assembly 11 covers a top portion (i.e., a lower portion, as viewed in the drawing) of the sensing element 2 which is sensitive to the oxygen in the measurement gas. The protective cover assembly 11 is made up of an outer and an inner cover which have gas inlets 110 through which the measurement gas flows inside or outside the protective cover assembly 11. The inner cover creates therein the measurement gas atmosphere 119.

An upper insulation porcelain 14 made of a hollow cylinder is laid on the lower insulation porcelain 13 in alignment therewith and covers a base portion (i.e., an upper portion, as viewed in the drawing) of the sensing element 2. An air cover 121 which is to be exposed to the air during use of the gas sensor is welded at an end thereof to a base end of the housing 10 to cover the upper insulation porcelain 14.

The air cover 121 is made up of a large-diameter portion, a small-diameter portion, and a shoulder 142 formed therebetween. The shoulder 142 works to urge the upper insulation porcelain 14 through an annular disc spring 141 into constant abutment with the base end of the lower insulation porcelain 13.

An outer air cover 122 is installed through a hollow cylindrical water-repellent filter 125 on an outer circumference of the based portion of the air cover 121. The installation is achieved by crimping the outer air cover 122 to retain the water-repellent filter 125 between the air cover 121 and the outer air cover 122. The air cover 121 and the outer air cover 122 have formed therein air vents 120 through which the air is admitted into an air chamber 124 through the water-repellent filter 125. The air chamber 124 is defined inside the air cover 121 leading to the air atmosphere 124. The air cover 121 has an open end closed hermetically by an elastic insulating holder 129.

The sensing element 2 has affixed thereon sensor signal output and power supply electrode terminals (not shown) with which spring terminals 151 abut at tips thereof. The spring terminals 151 extend at bases thereof outside the upper insulation porcelain 14 and connect with leads 153 through connectors 152. The leads 153 are retained in holes 128 formed in the insulating holder 129 and extend outside the insulating holder 129.

The housing 10 is made up of a base, a middle, and a top portion. The base portion is, as described above, welded to the air cover 121 and has a smaller diameter. The top portion has the protective cover assembly 11 installed in the end thereof and has a smaller diameter. The middle portion forms a flange and has a larger diameter. A spring 105 is placed beneath the lower surface of the middle portion. The top portion has formed on a circumferential surface a thread 106 which engages the sensor mount hole formed in the exhaust pipe 30. A spring 105 is placed between the lower surface of the middle portion and an outer wall 30 of the exhaust pipe 3 and serves as a washer A portion of the outer wall 100 of the gas sensor 1 placed inside the exhaust pipe 3, i.e., a side wall of the protective cover assembly 11 has the gas-exposed surface 101. Side walls of the base portion of the housing 11, the air cover 121, and the outer air cover 122 share the air-exposed surface 102 with each other.

The air cover 121 and the outer air cover 122 are each made of a stainless steel and have surfaces covered with oxidized films which occupy a portion of the outer wall 100 and/or at least a portion of the inner air-exposed surface 103. The formation of the oxidized films on the air cover 121 and the outer air cover 122 may be achieved by leaving the air cover 121 and the outer air cover 122 within an air atmosphere at 900° C. for five hours.

Heat-resistant austenitic stainless steel such as SUS310 or SUS316 may be employed as material of the air cover 121 and the outer air cover 122. The oxidized films cause the air cover 121 and the outer air cover 122 to be brown in color and dull in appearance, thereby providing desired emissivities to the air cover 121 and the outer air cover 122.

The emissivity which is a ratio of radiation emitted by the outer surfaces of the air cover 121 and the outer air cover 122 coated with the oxidized films to radiation emitted by a perfect blackbody radiator at the same temperature is 0.9 or more. The emissivity of the inner air-exposed surface 103 of the outer cover 121 covered with the oxidized film is 0.7 or more. Note that the emissivity, as used in the invention, is preferably a ratio of radiation of an electromagnetic wave whose wavelength is 3 to 25 μm (i.e., infrared light) emitted from a selected portion of the surface of the body of the gas sensor 1 to radiation emitted from a perfect blackbody radiator.

The heat dissipating from the exhaust gas is transmitted to the protective cover assembly 11, to the housing 10, and to the lower insulation porcelain 13, thus resulting in an elevated temperature within the gas sensor 1. The part of the heat is transmitted to the air-exposed surface 102 through the inner air-exposed surface 103 and released or radiated outside the gas sensor 1. Increasing the emissivities of the inner air-exposed surface 103 and the air-exposed surface 102, therefore, results in enhanced heat transmission and radiation from inside to outside the gas sensor 1, thereby decreasing the quantity of heat staying within the gas sensor 1 to minimize a rise in temperature within the gas sensor 1.

The water-repellent filter 125 is made from tetrafluoroethylene. The insulating holder 129 is made from fluorocarbon rubber.

Usually, a maximum temperature of exhaust gas of automotive engines is approximately 800° C. The gas sensor 1 is, as already described, heated by the exhaust gas during use up to a minimum of 300° C. and a maximum of 600° C. A peripheral portion A (i.e., the flange) of the housing 10, as illustrated in FIG. 1, located outside the exhaust pipe 3 has a maximum heat resistant to approximately 600° C. A portion B of the gas sensor 1 (i.e., the outer air cover 122) has a maximum heat resistant to approximately 300° C.

When placed at temperatures of 300° C. to 600° C., air-exposed portions of the gas sensor 1 (e.g., the housing 10, the air cover 121, etc.) usually emit electromagnetic waves of approximately 3 to 25 μm in wavelength (i.e., infrared light). If the air-exposed surface 102 including the outer surface of the air cover 121 and the inner air-exposed surface 103 is oxidized, but kept shiny or lustrous in appearance and has a lower emissivity, it will cause the temperature in the gas sensor 1 to rise undesirably, as discussed later, which may cause thermal damage to the water-repellent filer 125 and the elastic insulating holder 129. The air cover 121 of the gas sensor 1 of this embodiment has, as described above, the oxidized films affixed thereon to have an emissivity of at least 0.7, thereby minimizing a rise in temperature within the gas sensor 1 Instead of the oxidized films, the air cover 121 and/or the outer air cover 122 may be covered at least partly with a black coating (e.g., the high-temperature blackbody coating JSC-3 produced by Japan Sensor Corporation) to have an emissivity of 0.7 or more.

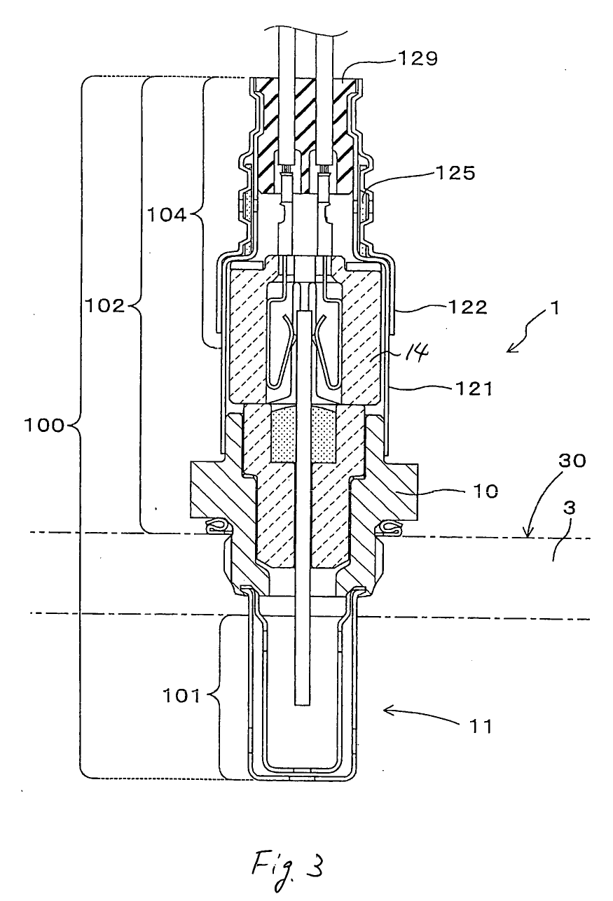

The outer air cover 122 partly surrounding the circumference of the air cover 121 may alternatively, as illustrated in FIG. 3, extend over the upper insulation porcelain 14. In this structure of the gas sensor 1, only a portion of the air-exposed surface 102, as denoted at 104, may have an emissivity of 0.7 or more, while the other portion may have an emissivity of less than 0.7.

The portion 104 of the air-exposed surface 102 has a length of 0.5H or more which extends from the base end (i.e., the upper end, as viewed in the drawing) of the gas sensor 1 in a longitudinal direction thereof where H is the overall length of the air-exposed surface 102 in the longitudinal direction of the gas sensor 1.

The elastic insulating holder 129 and the water-repellent filter 125 have thermal resistances lower than those of the other parts of the gas sensor 1. The elastic insulating holder 129 is, as described above, fitted hermetically within the base end of the air cover 121. The water-repellent filter 125 is placed inside the outer air cover 122 to admit the air into the gas sensor 1 (i.e., the air chamber 124). Specifically, the elastic insulating holder 129 and the water-repellent filter 125 are located at the base side of the gas sensor 1 away from a heat source (i.e., the exhaust gas in the exhaust pipe 30). The desired protection of the elastic insulating holder 129 and the water-repellent filter 125 from thermal damage is accomplished by making a portion of the gas sensor 1 within a range of 0.5H extending from the base end of the gas sensor 1 have an emissivity of 0.7 or more to minimize a rise in temperature in the base portion of the gas sensor 1.

The beneficial effects of the invention, as described above, may also be obtained by making only one of the air-exposed surface 102 and the inner air-exposed surface 103 have an emissivity of 0.7 or more. The increase in the emissivity may also be achieved, as already described, by spraying or flame-spraying a desired portion(s) of the gas sensor 1 with a black or dark brown heat-resistant coating or ferrite deposits. Further, the desired portion may alternatively be flame-sprayed with a high-temperature resistant alloy such as nichrome and then oxidized at high temperatures.

We prepared samples of the gas sensor 1 having different values of the emissivity and different high emissivity areas and performed tests on the samples in terms of the degree to which a rise in temperature within the gas sensor 1 is reduced.

The sample No. 0 was a reference sample in which the air cover 121, the outer air cover 122, and the housing 11 were heated and changed in color from brown to dark brown, but kept shiny in appearance.

Each of sample Nos. 1 to 8 was made up of three types: the first in which only the air-exposed surface 102 had a selected emissivity, the second in which only the inner air-exposed surface 103 had a selected emissivity, and the third in which both the air-exposed surface 102 and the inner air-exposed surface 103 had a selected emissivity.

The sample No. 1 had the air cover 121, the outer air cover 122, and the housing 11 which were brown in color and shiny slightly. The samples Nos. 2 to 5 were dark brown in color and dull in appearance. The sample No. 6 was heated at 900° C. for five hours so that it was darker in color than the samples Nos. 2 to 5 and dull in appearance. The sample No. 8 had the air cover 121, the outer air cover 122, and the housing 11 covered with the high-temperature blackbody coating JSC-3 produced by Japan Sensor Corporation.

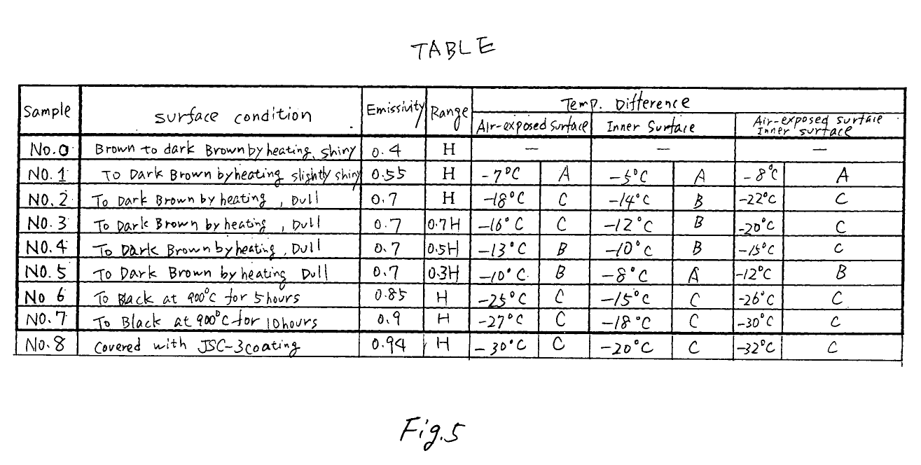

Each of the emissivities of the sample Nos. 1, 2, and 6 to 8 is uniform from the base to top end of either or both of the air-exposed surface 102 and the inner air-exposed surface 103. The range of each of the emissivities is expressed in table, as shown in FIG. 5, using the length H of the air-exposed surface 102.

The samples Nos. 3 to 5 each had an emissivity of 0.7 over selected areas of the air-exposed surface 102 and the inner air-exposed surface 103. Specifically, the first type of the sample No. 3 had an emissivity of 0.7 over the area of the air-exposed surface 102 within a range of 0.7H from the base end thereof. The second type of the sample No. 3 had an emissivity of 0.7 over the area of the inner air-exposed surface 103 within a range of 0.7H from the base end thereof. The third type of the sample No. 3 had an emissivity of 0.7 over both the areas of the air-exposed surface 102 and the inner air-exposed surface 103 within a range of 0.7H from the base end thereof. Similarly, the sample No. 4 had an emissivity of 0.7 within a range of 0.5H from the base end thereof. The sample No. 5 had an emissivity of 0.7 within a range of 0.3H from the base end thereof.

The emissivity of each of the samples Nos. 1 to 8, as listed in the table, is an average of emissivities measured at three different places thereof using a commercially available infrared emissivity meter.

The emissivities of the samples Nos. 1 to 8 were measured in the following manner.

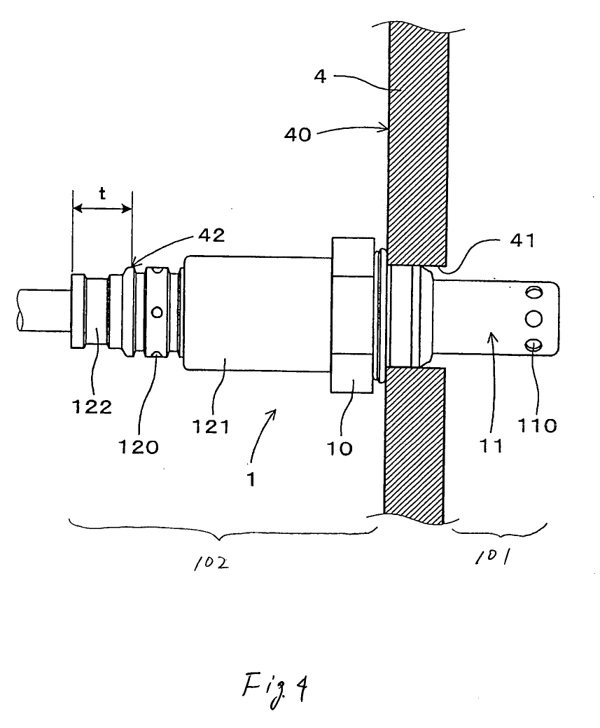

First, each sample, as denoted at numeral 1 in FIG. 4, was inserted into a mount hole 41 of a stationary fixing plate 4. The fixing plate 4 was heated up to 800° C. at an outer surface 40 thereof. After the sample was left as it was for 30 minutes to stabilize the temperature of a reference portion 42 of the sample, the temperature of the reference portion 42 was measured using a thermocouple affixed thereof. The reference portion 42 is located at a distance t of 10 mm away from the base end of the sample. The air-exposed surface 102 is on the left side, as viewed in the drawing, of the fixing plate 4, while the gas-exposed surface 101 is on the right side of the fixing plate 4. The temperature of the reference sample No. 0 is used in the table as an evaluation criterion. A temperature difference of each of the samples Nos. 1 to 8 from the evaluation criterion is represented in the table using symbols A, B, and C. The “A” stands for an unacceptable temperature difference less than 10° C. in absolute value. The “B” stands for an acceptable temperature difference less than 15° C. in absolute value. The “C” stands for a highly acceptable temperature difference more than 15° C. in absolute value.

The table shows that an emissivity of 0.7 or more serves to reduce a rise in temperature of the reference portion 42 desirably.

It is also found from the sample Nos. 2 to 5 that an emissivity of 0.7 or more is provided more preferably over a range of 0.5H or more from the base end of the gas sensor 1.

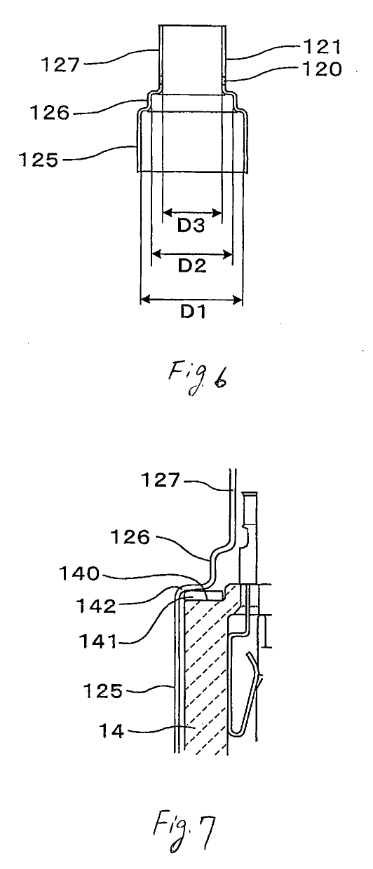

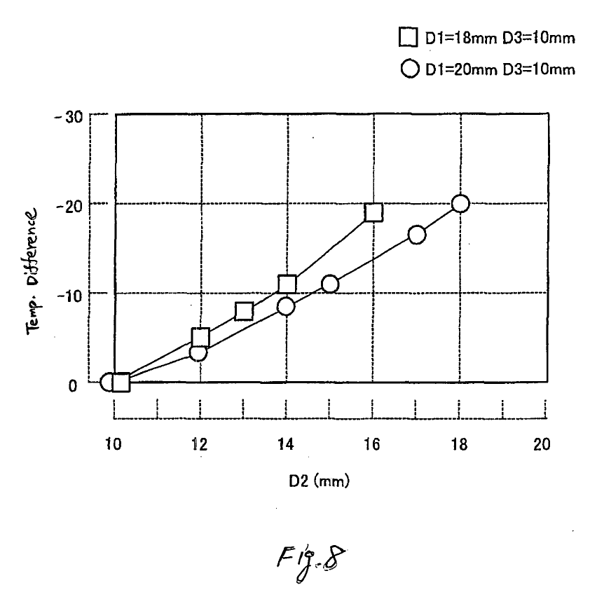

The gas sensor 1 of the second embodiment will be described below with reference to FIGS. 6 to 8.

The gas sensor 1 of this embodiment is substantially identical in structure with the one illustrated in FIGS. 1 and 2, and explanation thereof in detail will be omitted here except as described below.

The air cover 121 is, as illustrated in FIG. 6, made up of a large-diameter portion 125, a middle-diameter portion 126, and a small-diameter portion 127. The large-diameter portion 125, the middle-diameter portion 126, and the small-diameter portion 127 have inner diameters D1, D2, and D3, respectively. The diameters D1, D2, and D3 meet conditions of D3<D2<D1 and (D1+D3)/2≦=D2≦0.9D1. The diameters D1, D2, and D3 are maximum distances extending through the centers of cross sectional areas of the portions 125, 126, and 127 perpendicular to the longitudinal center line of the gas sensor 1 between diametrically opposed points on inner walls of the portions 125, 126, and 127, respectively.

We prepared two types of samples of the gas sensor 1 and performed tests to evaluate the heat radiation from the air cover 121. The first type samples are 20 mm in D1, 10 mm in D3, and different in D2 from each other. The second type samples are 18 mm in D1, 10 mm in D3, and different in D2 from each other. We measured the temperature of the first and second type samples in the same manner as described in the first embodiment. Test results are shown in a graph of FIG. 8. Note that the temperature of the outer surface 40 of the fixing plate 4 was 800° C.

The temperature of one of the first type samples having an inner diameter D2 of 10 mm is used in the graph as an evaluation criterion for each of the first type samples. Similarly, the temperature of one of the second type samples having an inner diameter D2 of 10 mm is used in the graph as an evaluation criterion for each of the second type samples. A temperature difference of each of the first and second type samples from a corresponding one of the evaluation criteria is represented in the ordinate axis.

In the first type samples, (D1+D3)/2 is 5 mm. In the second type samples, (D1+D3)/2 is 14 mm. The graph of FIG. 8 shows that it is advisable that the air cover 121 meet a condition of (D1+D3)/2≦D2 in order to achieve the heat radiation resulting in a temperature difference of 10° C. or more.

The air cover 121 is, like the first embodiment, fitted on the housing 10 in abutment of the annular disc spring 141 with the upper insulation porcelain 14. The shoulder 142 of the air cover 121 elastically urges the disc spring 141 into constant abutment with a shoulder 140 of the upper insulation porcelain 14. The securement of the disc spring 141 on the shoulder 140 requires a certain difference in diameter between the large-diameter portion 125 and the middle-diameter portion 126. We measured values of such differences in the first and second types samples and found that approximately 16 mm and 18 mm or more are unsuitable for installation of the air cover 121 or securement of the disc spring 141 on the upper insulation porcelain 14 in the first and second type samples, respectively, and it is advisable that the air cover 121 meet a condition of D2≦0.9D1.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor comprising:
a sensing element which is to be exposed to a measurement gas and works to produce a signal as a function of concentration of a specified component of the measurement gas; and
a body in which said sensing element is installed, said body having an outer wall which includes a gas-exposed surface and an air-exposed surface, the gas-exposed surface being to be exposed to the measurement gas, the air-exposed surface being to be exposed to an atmospheric air, at least a portion of the air-exposed surface having an emissivity of 0.7 or more.

2. A gas sensor as set forth in claim 1, wherein the emissivity of the at least the portion of the air-exposed surface is 0.85 or more.

3. A gas sensor as set forth in claim 1, wherein the emissiviy is a ratio of radiation of an electromagnetic wave whose wavelength is 3 to 25 μm emitted from the at least the portion of the air-exposed surface to radiation of that emitted from a perfect blackbody radiator at the same temperature.

4. A gas sensor as set forth in claim 1, wherein said body has a length with a base end and a top end opposed to the base end, the top end being to be exposed to the measurement gas, and wherein the at least the portion of the air-exposed surface having an emissivity of 0.7 or more occupies an area of the outer wall ranging over 0.5H from the base end in a lengthwise direction of said body where H is the length of said body.

5. A gas sensor as set forth in claim 1, wherein the at least the portion of the air-exposed surface is covered with an oxidized film.

6. A gas sensor as set forth in claim 1, wherein the at least the portion of the air-exposed surface is covered with a preselected coating.

7. A gas sensor as set forth in claim 1, wherein said body also has an inner wall which includes an inner surface opposed to the air-exposed surface, at least a portion of the inner surface having an emissivity of 0.7 or more.

8. A gas sensor as set forth in claim 7, wherein said body has a length with a base end and a top end opposed to the base end, the top end being to be exposed to the measurement gas, and wherein the at least the portion of the inner surface having an emissivity of 0.7 or more occupies an area of the inner wall ranging over 0.5H from the base end in a lengthwise direction of said body where H is the length of said body.

9. A gas sensor as set forth in claim 1, wherein said sensing element includes a top end portion and a base end portion opposed to the top end portion, the top end portion being to be exposed to the measurement gas, working to produce the signal as a function of the concentration of the specified component of the measurement gas,
and further comprising: a hollow cylindrical housing having a top end close to the top end portion of said sensing element and a base end close to the base end portion of said sensing element;
a first cylindrical insulator through which said sensing element passes, said first cylindrical insulator being disposed in said housing, having a top end close to the top end of said sensing element and a base end close to the base end of said sensing element;
a second cylindrical insulator having a base end close to the base end portion of said sensing element and a top end close to the top end portion of said sensing element, said second cylindrical insulator disposed at the top end thereof on the base end of said first cylindrical insulator to cover the base end portion of said sensing element;
a measurement gas cover installed on the top end of said housing to cover the top end portion of said sensing element; and
an air cover installed on the base end of said housing to cover the base end portion of said sensing element, said air cover being to be exposed to an atmospheric air, having a top end close to the top end of said sensing element and a base end close to the base end of said sensing element, and
wherein said air cover includes a base portion, a top portion, a middle portion between the base portion and the top portion, and a shoulder between the base portion and the middle portion, the shoulder being in abutment with the base end of said second cylindrical insulator through an annular disc spring to establish a joint of said first and second cylindrical insulators, and wherein the base portion has a diameter D1, the middle portion has a diameter D2, the top portion has a diameter D3, the diameters D1, D2, and D3 meeting conditions of D3<D2<D1 and (D1+D3)/2≦D2≦0.9D1.

10. A gas sensor comprising:
a sensing element which is to be exposed to a measurement gas and works to produce a signal as a function of concentration of a specified component of the measurement gas; and
a body in which said sensing element is installed, said body having an outer wall which includes a gas-exposed surface and an air-exposed surface, the gas-exposed surface being to be exposed to the measurement gas, the air-exposed surface being to be exposed to an atmospheric air, said body also having an inner wall which includes an inner surface opposed to the air-exposed surface, at least a portion of the inner surface having an emissivity of 0.7 or more.

11. A gas sensor as set forth in claim 10, wherein the emissivity of the at least the portion of the inner surface is 0.85 or more.

12. A gas sensor as set forth in claim 10, wherein the emissiviy is a ratio of radiation of an electromagnetic wave whose wavelength is 3 to 25 μm emitted from the at least the portion of the inner wall to radiation of that emitted from a perfect blackbody radiator at the same temperature.

13. A gas sensor as set forth in claim 10, wherein said body has a length with a base end and a top end opposed to the base end, the top end being to be exposed to the measurement gas, and wherein the at least the portion of the inner surface having an emissivity of 0.7 or more occupies an area of the inner wall ranging over 0.5H from the base end in a lengthwise direction of said body where His the length of said body.

14. A gas sensor as set forth in claim 10, wherein the at least the portion of the inner surface is covered with an oxidized film.

15. A gas sensor as set forth in claim 10, wherein the at least the portion of the inner surface is covered with a preselected coating.

16. A gas sensor as set forth in claim 10, wherein said sensing element includes a top end portion and a base end portion opposed to the top end portion, the top end portion being to be exposed to the measurement gas, working to produce the signal as a function of the concentration of the specified component of the measurement gas,
and further comprising: a hollow cylindrical housing having a top end close to the top end portion of said sensing element and a base end close to the base end portion of said sensing element;
a first cylindrical insulator through which said sensing element passes, said first cylindrical insulator being disposed in said housing, having a top end close to the top end of said sensing element and a base end close to the base end of said sensing element;
a second cylindrical insulator having a base end close to the base end portion of said sensing element and a top end close to the top end portion of said sensing element, said second cylindrical insulator disposed at the top end thereof on the base end of said first cylindrical insulator to cover the base end portion of said sensing element;
a measurement gas cover installed on the top end of said housing to cover the top end portion of said sensing element; and
an air cover installed on the base end of said housing to cover the base end portion of said sensing element, said air cover being to be exposed to an atmospheric air, having a top end close to the top end of said sensing element and a base end close to the base end of said sensing element, and
wherein said air cover includes a base portion, a top portion, a middle portion between the base portion and the top portion, and a shoulder between the base portion and the middle portion, the shoulder being in abutment with the base end of said second cylindrical insulator through an annular disc spring to establish a joint of said first and second cylindrical insulators, and wherein the base portion has a diameter D1, the middle portion has a diameter D2, the top portion has a diameter D3, the diameters D1, D2, and D3 meeting conditions of D3<D2<D1 and (D1+D3)/2≦D2≦0.9D1.
